(19) United States
(12) Patent Application Publication
(10) Pub. No.: US 2026/0147761 A1
(43) Pub. Date: May 28, 2026

(54) UNIFIED EMBEDDING MODEL FOR INFORMATION RETRIEVAL AND CUSTOMIZATION

(71) Applicant: Maplebear Inc., San Francisco, CA (US)

(72) Inventors: Chuanwei Ruan, Sunnyvale, CA (US); Guanghua Shu, Sunnyvale, CA (US); Xiao Xiao, San Diego, CA (US); Yunzhi Ye, Bothell, WA (US); Haixun Wang, Bellevue, WA (US); Tejaswi Tenneti, San Carlos, CA (US)

(21) Appl. No.: 18/963,705

(22) Filed: Nov. 28, 2024

(51) Int. Cl. G06F 16/2453; G06N 3/084

(52) U.S. Cl. CPC G06F 16/24549; G06N 3/084

(57) ABSTRACT

A system trains and deploys a unified embedding model configured to generate embeddings for a set of different entity types based on a natural language description of the entities. The system obtains training data including a plurality of pairs, wherein a pair includes a query entity and a target entity. The system divides the training data into one or more batches for training a transformer embedding model. The system, for each iteration of one or more iterations, applies parameters of the transformer embedding model to generate estimated query entity embeddings for the query entities, and to generate estimated target entity embeddings for the target entities. The system computes corresponding dot products between the estimated query entity embeddings and the estimated target entity embeddings. The system computes a loss function that is proportional to the dot product. The system updates the parameters of the transformer embedding model.

### BACKGROUND

An online system executes one or more machine-learning embedding models to map different entities (e.g., users, items, retailers) to embedding vectors in a latent space. By mapping the entities to embeddings, the relevance between a pair of entities (e.g., user and item pair) can be predicted and used, for example, to generate recommendations to users. However, typically the online system trains and deploys separate machine-learning models for different entities or different pairs of entity types. For example, the online system may train a first model for modeling user and item embeddings and a separate second model for modeling search query and item embeddings. This results in a significant overhead in computational resources and time as well as memory requirements for storing these separate models that can often have many parameters.

### SUMMARY

In some aspects, the techniques described herein relate to a system to train and deploy a unified embedding model configured to generate embeddings for a set of different types of entities based on a natural language description of the entities. The system obtains training data including a plurality of pairs, wherein a pair includes a respective query entity and a respective target entity. The system accesses a transformer embedding model. The system divides the training data into one or more batches for one or more iterations of training the transformer embedding model. The system, for each iteration of one or more iterations, applies parameters of the transformer embedding model to descriptions of query entities for a first set of pairs for a current iteration to generate estimated query entity embeddings for the query entities. The system, for each iteration of one or more iterations, applies parameters of the transformer embedding model to descriptions of target entities for the respective set of pairs for the current iteration to generate estimated target entity embeddings for the target entities. The system, for each iteration of one or more iterations, computes dot products between the estimated query entity embeddings and the estimated target entity embeddings corresponding to each pair in the first set of pairs. The system for each iteration of one or more iterations, computes a loss function that is proportional to the dot products for the first set of pairs. The system, for each iteration of one or more iterations, updates the parameters of the transformer model by backpropagating one or more terms obtained by the loss function.

### BRIEF DESCRIPTION OF THE DRAWINGS

FIG. 1A illustrates an example system environment for an online system, in accordance with some embodiments.

FIG. 1B illustrates an example system environment for an online system, in accordance with some embodiments.

FIG. 2 illustrates an example system architecture for an online system, in accordance with some embodiments.

FIG. 3 is a block diagram illustrating an example system for applying a unified embedding model for different entity types, in accordance with some embodiments.

FIG. 4 illustrates an example training dataset for a training iteration for the unified embedding model, in accordance with some embodiments.

FIG. 5A illustrates generating embeddings for query entities, in accordance with some embodiments.

FIG. 5B illustrates generating embeddings for target entities, in accordance with some embodiments.

FIG. 6 illustrates computing a dot product between query entity and target entity embeddings during the training process, in accordance with some embodiments.

FIG. 7 is a flowchart for training a unified embedding model, in accordance with some embodiments.

### DETAILED DESCRIPTION

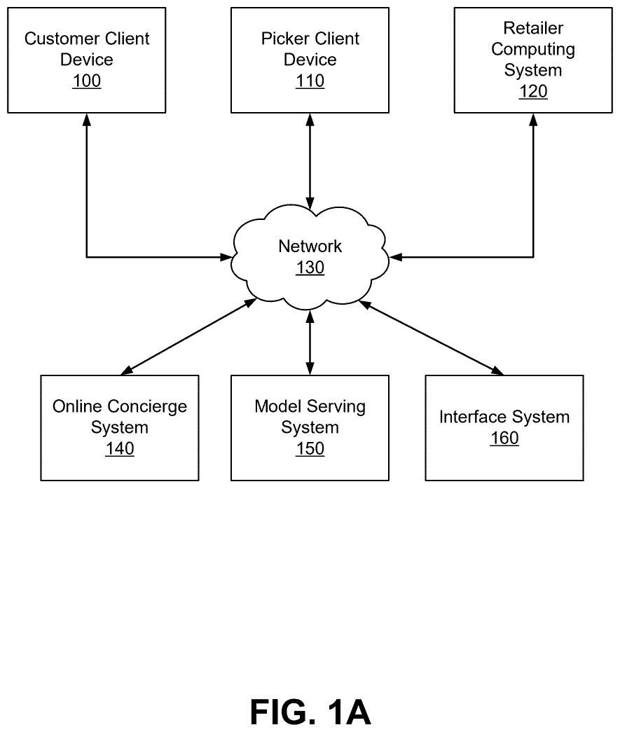

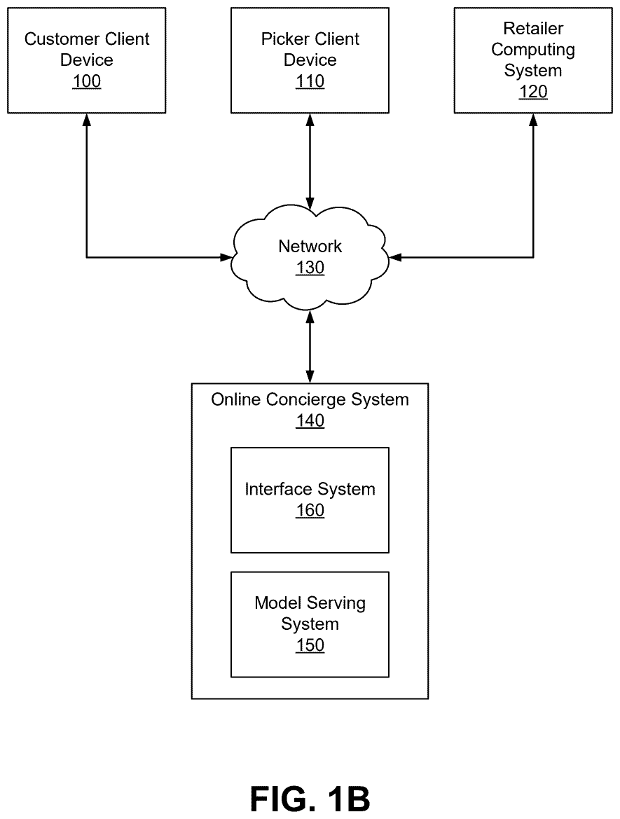

FIG. 1A illustrates an example system environment for an online concierge system 140, in accordance with some embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online concierge system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In some embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online concierge system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online concierge system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

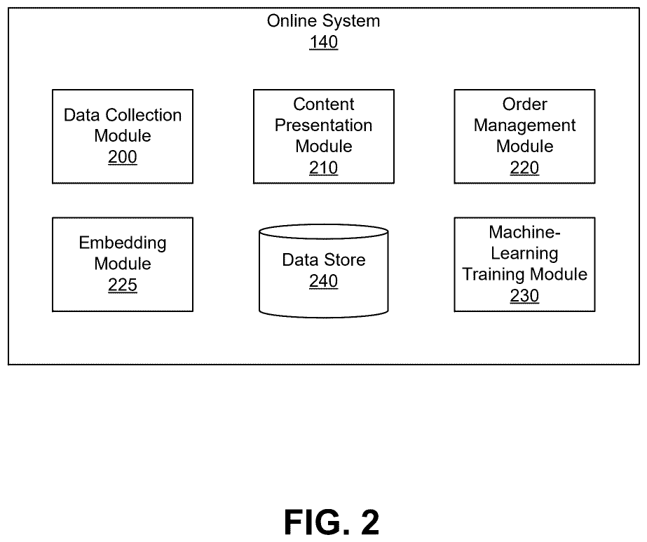

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online concierge system 140 is described in further detail below with regards to FIG. 2.

The model serving system 150 receives requests from the online concierge system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online concierge system 140 or one or more entities different from the online concierge system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the online system 140 trains and deploys a unified embedding model configured to generate embeddings for a set of entity types based on a natural language description of the entities. Specifically, the online system 140 obtains training data including a plurality of pairs, wherein a pair includes a query entity and a target entity. The online system 140 divides the training data into one or more batches, for one or more iterations, to train a transformer embedding model. The online system 140, for each iteration of one or more iterations, applies parameters of the transformer embedding model to descriptions of query entities to generate estimated query entity embeddings for the query entities, and applies parameters of the transformer embedding model to descriptions of target entities to generate estimated target entity embeddings. For each iteration of one or more iterations, the online system 140 computes a dot product between the estimated query entity embeddings and the estimated target entity embeddings corresponding to each pair in the first set of pairs. For each iteration of one or more iterations, the online system 140 computes a loss function that is proportional to the dot products for the first set of pairs and updates the parameters of the transformer model by backpropagating one or more terms obtained by the loss function.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online concierge system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

In one or more embodiments, for an order of a user, the online concierge system 140 performs a query to a machine-learned model for pairing information. Specifically, the online system 140 provides external data relating to the pairing of alcohol and food to the model serving system 150. The online system 140 provides a request to the model serving system 150 to infer alcohol pairings for the order given the list of items and previous user shopping history for the user. The online system 140 receives a response to the prompt from the model serving system 150 based on execution of the machine-learned model. The online system 140 obtains the response and includes the external pairing data in the personalized recommendations for alcohol pairings to the user. In some embodiments, the online concierge system 140 uses the external pairing data to sort the list of potential alcohol candidates into a final recommendation.

FIG. 1B illustrates an example system environment for an online system 140, in accordance with some embodiments. The system environment illustrated in FIG. 1B includes a customer client device 100, a picker client device 110, a retailer computing system 120, a network 130, and an online concierge system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online concierge system 140. In one or more embodiments, as illustrated in the example system environment in FIG. 1B, the model serving system 150 and/or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and offers the orders to pickers for service based on picker data. For example, the order management module 220 offers an order to a picker based on the picker's location and the location of the retailer from which the ordered items are to be collected. The order management module 220 may also offer an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to offer an order to a picker based on a delivery timeframe requested by the customer with the order. The order management module 220 computes an estimated amount of time that it would take for a picker to collect the items for an order and deliver the ordered item to the delivery location for the order. The order management module 220 offers the order to a picker at a time such that, if the picker immediately services the order, the picker is likely to deliver the order at a time within the timeframe. Thus, when the order management module 220 receives an order, the order management module 220 may delay in offering the order to a picker if the timeframe is far enough in the future.

When the order management module 220 offers an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The embedding module 225 trains and deploys a unified embedding model configured to generate embeddings for a set of different types of entities based on a natural language description of the entities. Oftentimes online systems map different entity types in a vector space to model different interactions within the online system. Current online systems generate vector embeddings by applying a separate embedding model for each entity type. Such embedding models are trained separately based on their entity type which can be computationally expensive and time consuming.

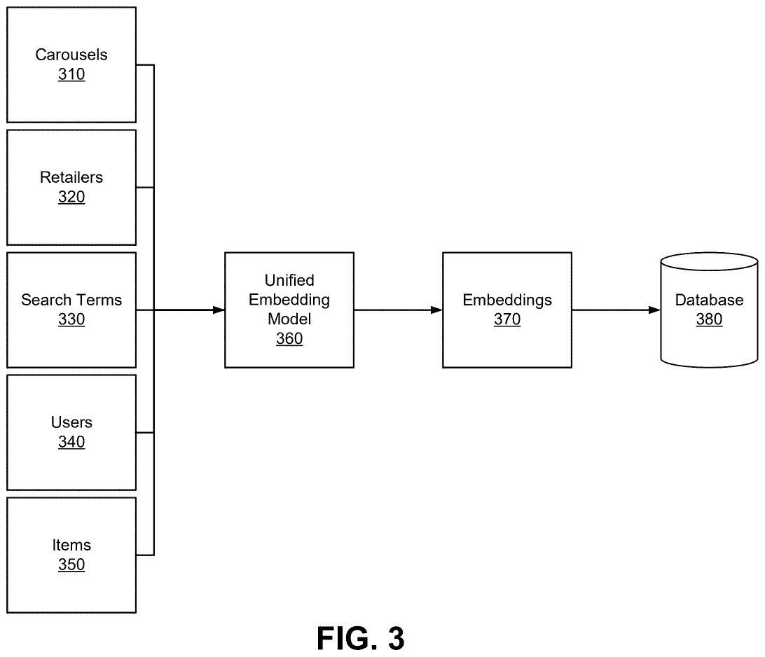

An entity is a component of the online system 140, such as carousel or placement of items, users, items, and the like. An entity pair includes the notion of a query entity and a target entity. For a given query entity, the target entity is an entity that may be related to the query entity. As an example, one entity pair may be recommending a set of items for a user, wherein the user is the query entity, and the target is the set of recommended items for the user. FIG. 3 illustrates applying a unified embedding model 360 to different entity types, in accordance with some embodiments. As discussed above, in the online system 140, models are designed to process pairs of entities, comprising a query entity and a target entity, with a goal of identifying one or more target entities related to the query entity. For example, in response to a user query, the system may determine target entities such as items or content that the user is likely to be interested in.

In the workflow of FIG. 3, the embedding module 225 processes a natural language description of a set of entities to generate corresponding embeddings for entity pairs. The set of entities include carousel data 310, retailers 320, search terms 330, users 340, and/or item data 350. The embedding module 225 receives a description of entities. As an example, the embedding module 225 receives a natural language description of a user as a query entity after receiving consent from the user. The embedding module 225 may also receive natural language descriptions of one or more items as target entities. The embedding module 225 receives these target and query entity pairs and applies a unified embedding model 360 to generate vector embeddings 370 for each of the query entities and target entities. The resulting embeddings 370 are stored in a database 380 for future retrieval.

During real-time, a query entity embedding is combined with a respective target entity embedding to determine a likelihood the target entity is related to the query entity. In one or more embodiments, the combination is a dot product between the two embeddings, in which a higher value of dot product indicates a higher degree of relevance and a lower value of dot product indicates a lower degree of relevance between the two entities. In this manner, the embeddings can be pre-computed and stored in the database 380 and quickly retrieved when, for example, the entity corresponding to an entity is needed to determine the relevance.

While a user entity as a query entity and an item entity as a target entity is used as an example, it is appreciated that in other embodiments, the query entity and target entity can be any appropriate entity for which relevance between the two are determined to generate recommendations or predictions. For example, a query entity may be an item entity (e.g., milk) and a target entity may be another item entity (e.g., oat milk) and the embeddings for these entities may be combined to generate a prediction of whether the target entity can be a replacement item for the query entity. As another example, a query entity may be a search entity (e.g., search terms “milk”) and a target entity may be an item entity (e.g., ABC Co. milk) and the embeddings for these entities may be combined to generate a prediction of whether the target entity should be recommended as part of search results for the search query.

In one or more embodiments, the embedding module 225 trains the parameters of the unified embedding model by performing one or more iterations using training data. In one or more embodiments, the training data includes a set of query entity and target entity pairs that are known to be related to each other. In one or more embodiments, the embedding module 225 divides training data into one or more batches for one or more iterations of the training process for the unified embedding model 360.

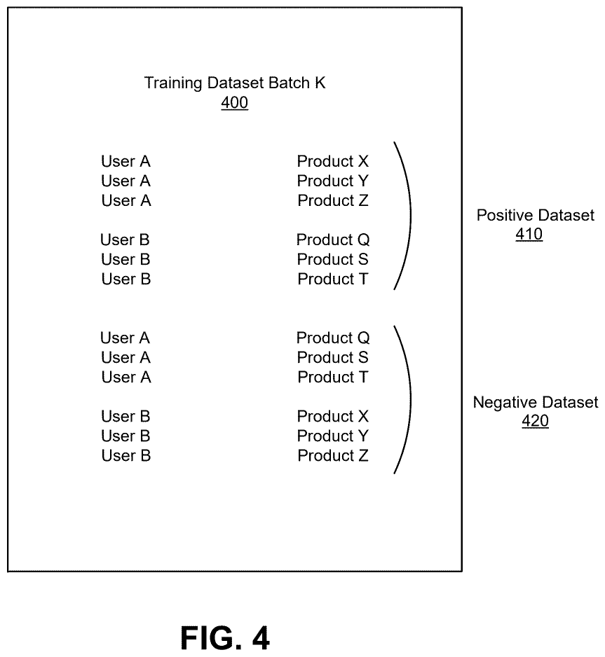

FIG. 4 illustrates an example training dataset for a training iteration for the unified embedding model, in accordance with some embodiments. In one or more embodiments, for a batch for a given iteration, the embedding module 225 constructs a positive dataset and a negative dataset for the batch. In the example training data shown in FIG. 4, the embedding module 225 obtains training data including a plurality of pairs, wherein a pair includes a description of the query entity and a description of the target entity. Specifically, the embedding module 225 obtains training data for the query entity of a user and the target entities of items the respective user is interested in. For example, the embedding module 225 receives training data for the entity pair of User A and the item, Product X, that User A is interested in after receiving consent from User A.

In FIG. 4, the training batch K 400 includes a positive dataset 410 and a negative dataset 420. In FIG. 4, the entity pair is a query entity for a set of users and the target entity is items recommended to the set of users. To obtain the positive pairs in the positive dataset, the embedding module 225 may access the order history for the set of users after receiving the consent of the users. For example, the embedding module 225 generates the positive dataset 410 for User A by accessing a list of User A's recently ordered items (Product X, Product Y, and Product Z). A negative pair consists of a user and a target entity that does not match the query entity within the given batch. For example, a negative pair is created by pairing a user with a target entity from another user entity in the same batch. To generate the negative dataset 420, the embedding module 225 generates a dataset pair for the User A and an item in User B's recently ordered list, wherein the item is not in User A's recently ordered list.

In one or more embodiments, the unified embedding model is configured as a transformer architecture including a set of attention layers. Each attention layer receives inputs obtained from input tokens representing the description of an entity and generates queries, keys, and values. The queries, keys, and values are combined to generate attention outputs for the attention layer that are provided as inputs to the next layer until an embedding (i.e., vector of 1024 elements) is generated for the entity.

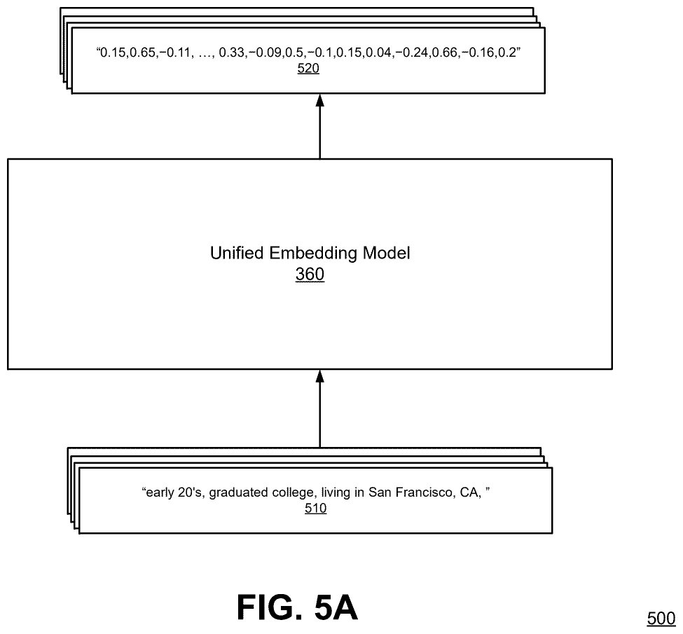

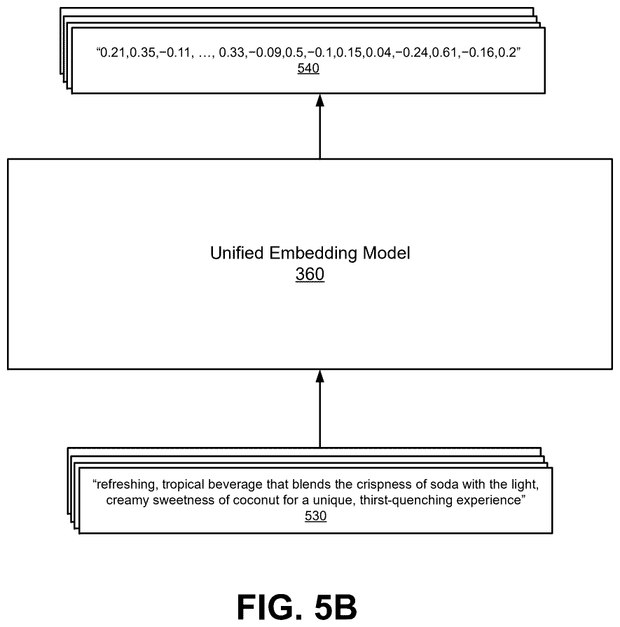

The embedding module 225 obtains estimated embeddings for the query entities and the target entities for a batch. FIG. 5A illustrates the process of generating an estimated embedding for descriptions of the one or more query entities, in accordance with one or more embodiments. For each iteration of one or more iterations, the embedding module 225 applies the parameters of the unified embedding model 360 to the natural language description of the query entities for a respective batch of entity pairs. This process generates estimated query entity embeddings for a received set of query entity descriptions by using the model's parameters at the time of the iteration. As an example, in FIG. 5A, the unified embedding model 360 receives a description of User A 510: “early 20's, graduated college, living in San Francisco, CA,” and generates a corresponding vector embedding 520 for the user.

FIG. 5B illustrates the process of generating an estimated embedding for descriptions of one or more query entities, in accordance with one or more embodiments. For each iteration of one or more iterations, the embedding module 225 applies the parameters of the unified embedding model 360 to the natural language description of the target entities for the respective batch of entity pairs. This process generates estimated target entity embeddings for the received set of target entity descriptions by using the model's learned parameters at the time of the iteration. As an example, in FIG. 5B, the unified embedding model 360 receives a description of a coconut soda 530: “refreshing, tropical beverage that blends the crispness of soda with the light, creamy sweetness of coconut for a unique, thirst-quenching experience” and generates a corresponding vector embedding 540 of the coconut soda.

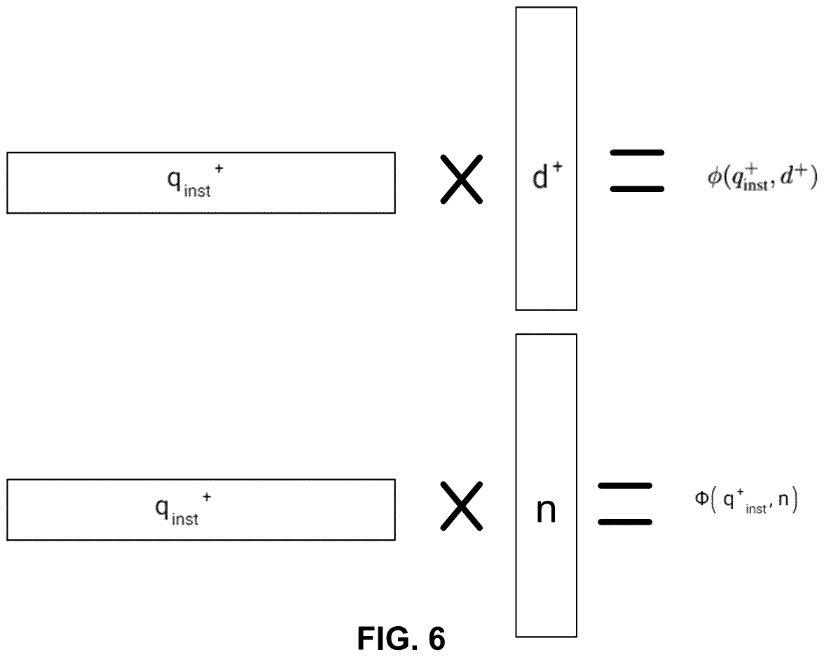

The embedding module 225 computes a loss function using the estimated embeddings. In one or more embodiments, the embedding module 225 uses a noise contrastive estimation (NCE) loss. In FIG. 6, for at least one iteration, the embedding module 225 calculates a dot product between the estimated query entity embeddings and the estimated target entity embeddings for the set of positive pairs. For example, in FIG. 6, the query instance qᵢₙₛₜ⁺ represents a user entity, while d⁺ represents a positive target item for an item. The dot product, φ, is computed between the estimated embeddings of these two entities. This process is iteratively performed for other pairs in the positive set, ensuring all relevant entity embeddings undergo the dot product estimation.

Similarly, for at least an iteration, the embedding module 225 calculates a dot product between the estimated query entity embeddings and the estimated target entity embeddings for the set of negative pairs for the query entity. For example, in FIG. 6, the query instance

$${q}_{inst}^{+}$$

represents a user entity, while nᵢ represents a negative target item for the query entity. The dot product, φ, is computed between the estimated embeddings of these two entities. This process is iteratively performed for other pairs in the negative set, ensuring all relevant entity embeddings undergo the dot product estimation.

The embedding module 225 computes a loss function that is proportional to the estimated dot products of the positive dataset in a respective batch and is inversely proportional to the estimated dot products of the negative dataset in a respective batch for a given query entity. In one or more embodiments, the loss function is given by:

$$L = log log \frac{ϕ ( {q}_{inst}^{+} , {d}^{+} )}{ϕ ( {q}_{inst}^{+} , {d}^{+} ) + {\sum }_{i = 0}^{N} ϕ ( {q}_{inst}^{+} , {n}_{i} )}$$

where i=0, 1, . . . , N is the number of negative target entities for the query entity.

The embedding module 225 obtains one or more terms from the loss function and backpropagates the one or more terms to update parameters of the unified embedding model. This process is repeated for subsequent iterations of the training process using different sets of batches until a convergence criterion is reached. In one instance, the convergence criterion is that a change between parameter values within a subset of iterations is less than a threshold.

While the training process is described herein using a user as a query entity and an item as a target entity as a primary example, this is for the sake of illustration. In one or more embodiments, it is appreciated that the embedding module 225 may obtain a training dataset that includes the descriptions of query entities and target entities for which the unified embedding model is being trained for and perform a similar process as that described above to further train the parameters to learn the relationships between different types of entities. For example, for another one or more iterations, the embedding module 225 may obtain training data including pairs of a search query and corresponding items that are known to have resulted in users clicking or purchasing the items when the items were provided in the search results. The embedding module 225 may train the parameters of the unified embedding model using the training data. In this way, the unified embedding model may learn relationships between different types of query entities and target entities in a single model with a shared set of parameters. For example, this is beneficial for users as users can be presented with a better set of recommendations and items that are relevant to what the user is looking for and is more relevant to the user.

In one or more embodiments, after the unified embedding model is trained, the embedding module 225 may deploy the unified embedding model to generate, for example, recommendations, items retrieved for search queries, and the like. Specifically, for a query entity (e.g., search query), parameters of the unified embedding model are applied to generate an embedding for the query entity. The online system 140 also applies the parameters of the unified embedding model to one or more potential target entities (e.g., items for retrieval) to generate embeddings for the target entities. The embeddings for the query entity and target entities are combined to generate likelihoods of whether a respective target entity is relevant to the query entity. As described above in conjunction with FIG. 1, this is technically advantageous as the online system 140 does not have to maintain and retrieve separate embedding models for different pairs of query and target entities. The computational savings are especially large when the embeddings models have a larger number of parameters.

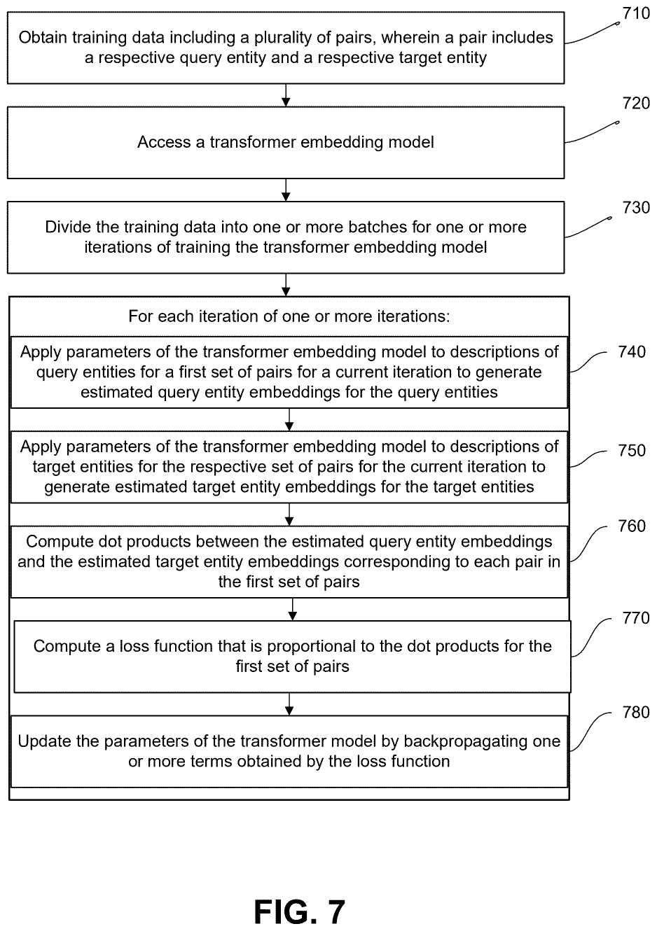

FIG. 7 is a flowchart for training a unified embedding model, in accordance with some embodiments. Alternative embodiments may include more, fewer, or different steps from those illustrated in FIG. 7 and the steps may be performed in a different order from that illustrated in FIG. 7. These steps may be performed by an online concierge system (e.g., online system 140). Additionally, each of these steps may be performed automatically by the online system 140 without human intervention.

The online system obtains 710 training data including a plurality of pairs, wherein a pair includes a respective query entity and a respective target entity. The online system accesses 720 a transformer embedding model. The online system 730 divides the training data into one or more batches for one or more iterations of training the transformer embedding model. For each iteration of one or more iterations, the online system applies 740 parameters of the transformer embedding model to descriptions of query entities for a first set of pairs for a current iteration to generate estimated query entity embeddings for the query entities. For each iteration of one or more iterations, the online system applies 750 parameters of the transformer embedding model to descriptions of target entities for the respective set of pairs for the current iteration to generate estimated target entity embeddings for the target entities. For each iteration of one or more iterations, the online system computes 760 dot products between the estimated query entity embeddings and the estimated target entity embeddings corresponding to each pair in the first set of pairs. For each iteration of one or more iterations, the online system computes 770 a loss function that is proportional to the dot products for the first set of pairs. For each iteration of one or more iterations, the online system updates 780 the parameters of the transformer model by backpropagating one or more terms obtained by the loss function.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
obtaining training data including a plurality of pairs, wherein a pair includes a respective query entity and a respective target entity;
accessing a transformer embedding model;
dividing the training data into one or more batches for one or more iterations of training the transformer embedding model; and
for each iteration of one or more iterations:
applying parameters of the transformer embedding model to descriptions of query entities for a first set of pairs for a current iteration to generate estimated query entity embeddings for the query entities;
applying parameters of the transformer embedding model to descriptions of target entities for the respective set of pairs for the current iteration to generate estimated target entity embeddings for the target entities;
computing dot products between the estimated query entity embeddings and the estimated target entity embeddings corresponding to each pair in the first set of pairs;
computing a loss function that is proportional to the dot products for the first set of pairs;
updating the parameters of the transformer embedding model by backpropagating one or more terms obtained by the loss function;
generating one or more query entity embeddings and one or more target entity embeddings using the transformer embedding model; and
transmitting instructions to a client device to cause display of one or more target entities corresponding to the one or more target entity embeddings.

2. The method of claim 1, further comprising, for the current iteration:
obtaining a second set of pairs for the current iteration, wherein a pair in the second set of pairs includes the respective query entity and a negative target entity; and
computing, for each pair in the second set of pairs, a dot product between the estimated query entity embedding and the corresponding estimated target entities embedding.

3. The method of claim 2, wherein the loss function is inversely proportional to the dot products for the second set of pairs.

4. The method of claim 1, wherein the query entity of the pair represents a user of an online system and the target entity of the pair represents an item the user interacted with.

5. The method of claim 1, wherein the query entity of the pair represents an item and the target entity of the pair represents another item that is known to be a replacement for the item.

6. The method of claim 1, wherein responsive to performing the one or more iterations, further comprises:
applying the parameters of the transformer embedding model to descriptions of a plurality of query entities to generate query entity embeddings;
applying the parameters of the transformer embedding model to descriptions of a plurality of target entities to generate target entity embeddings; and
storing the query entity embeddings and the target entity embeddings in a datastore.

7. The method of claim 6, further comprising:
identifying an opportunity to present a plurality target entities for a particular query entity;
retrieving a query entity embedding for the particular query entity and the target entity embeddings for the plurality of target entities;
computing dot products between the query entity embedding and the plurality of target entity embeddings to generate a plurality of scores;
selecting a subset of target entities based on the plurality of scores; and
transmitting instructions to a client device of a user to display the selected subset of target entities on the client device.

8. A non-transitory computer-readable storage medium storing computer instructions, the computer instructions, when executed by one or more processors, cause the one or more processors to:
obtain training data including a plurality of pairs, wherein a pair includes a respective query entity and a respective target entity;
access a transformer embedding model;
divide the training data into one or more batches for one or more iterations of training the transformer embedding model; and
for each iteration of one or more iterations:
apply parameters of the transformer embedding model to descriptions of query entities for a first set of pairs for a current iteration to generate estimated query entity embeddings for the query entities;
apply parameters of the transformer embedding model to descriptions of target entities for the respective set of pairs for the current iteration to generate estimated target entity embeddings for the target entities;
compute dot products between the estimated query entity embeddings and the estimated target entity embeddings corresponding to each pair in the first set of pairs;
compute a loss function that is proportional to the dot products for the first set of pairs; and
update the parameters of the transformer embedding model by backpropagating one or more terms obtained by the loss function;
generate one or more query entity embeddings and one or more target entity embeddings using the transformer embedding model; and
transmit instructions to a client device to cause display of one or more target entities corresponding to the one or more target entity embeddings.

9. The non-transitory computer-readable storage medium of claim 8, wherein the computer instructions, when executed by the one or more processors, for the current iteration, cause the one or more processors to:
obtain a second set of pairs for the current iteration, wherein a pair in the second set of pairs includes the respective query entity and a negative target entity; and
compute, for each pair in the second set of pairs, a dot product between the estimated query entity embedding and the corresponding estimated target entities embedding.

10. The non-transitory computer-readable storage medium of claim 9, wherein the loss function is inversely proportional to the dot products for the second set of pairs.

11. The non-transitory computer-readable storage medium of claim 8, wherein the query entity of the pair represents a user of an online system and the target entity of the pair represents an item the user interacted with.

12. The non-transitory computer-readable storage medium of claim 8, wherein the query entity of the pair represents an item and the target entity of the pair represents another item that is known to be a replacement for the item.

13. The non-transitory computer-readable storage medium of claim 8, wherein the computer instructions that cause the one or more processors, responsive to performing the one or more iterations further cause the one or more processors to:
apply the parameters of the transformer embedding model to descriptions of a plurality of query entities to generate query entity embeddings;
apply the parameters of the transformer embedding model to descriptions of a plurality of target entities to generate target entity embeddings; and
store the query entity embeddings and the target entity embeddings in a datastore.

14. The non-transitory computer-readable storage medium of claim 13, wherein the computer instructions, when executed by the one or more processors, for the current iteration, cause the one or more processors to:
identify an opportunity to present a plurality target entities for a particular query entity;
retrieve a query entity embedding for the particular query entity and the target entity embeddings for the plurality of target entities;
compute dot products between the query entity embedding and the plurality of target entity embeddings to generate a plurality of scores;
select a subset of target entities based on the plurality of scores; and
transmit instructions to a client device of a user to display the selected subset of target entities on the client device.

15. A computer system comprising:
a processor; and
a non-transitory computer readable storage medium storing instructions that, when executed by the processor, cause the processor to perform actions comprising:
obtaining training data including a plurality of pairs, wherein a pair includes a respective query entity and a respective target entity;
accessing a transformer embedding model;
dividing the training data into one or more batches for one or more iterations of training the transformer embedding model; and
for each iteration of one or more iterations:
applying parameters of the transformer embedding model to descriptions of query entities for a first set of pairs for a current iteration to generate estimated query entity embeddings for the query entities;
applying parameters of the transformer embedding model to descriptions of target entities for the respective set of pairs for the current iteration to generate estimated target entity embeddings for the target entities;
computing dot products between the estimated query entity embeddings and the estimated target entity embeddings corresponding to each pair in the first set of pairs;
computing a loss function that is proportional to the dot products for the first set of pairs; and
updating the parameters of the transformer embedding model by backpropagating one or more terms obtained by the loss function;
generating one or more query entity embeddings and one or more target entity embeddings using the transformer embedding model; and
transmitting instructions to a client device to cause display of one or more target entities corresponding to the one or more target entity embeddings.

16. The computer system of claim 15, further comprising, for the current iteration:
obtaining a second set of pairs for the current iteration, wherein a pair in the second set of pairs includes the respective query entity and a negative target entity; and
computing, for each pair in the second set of pairs, a dot product between the estimated query entity embedding and the corresponding estimated target entities embedding.

17. The computer system of claim 16, wherein the loss function is inversely proportional to the dot products for the second set of pairs.

18. The computer system of claim 15, wherein the query entity of the pair represents a user of an online system and the target entity of the pair represents an item the user interacted with.

19. The computer system of claim 15, wherein the query entity of the pair represents an item and the target entity of the pair represents another item that is known to be a replacement for the item.

20. The computer system of claim 15, wherein responsive to performing the one or more iterations, further comprises:
applying the parameters of the transformer embedding model to descriptions of a plurality of query entities to generate query entity embeddings;
applying the parameters of the transformer embedding model to descriptions of a plurality of target entities to generate target entity embeddings; and
storing the query entity embeddings and the target entity embeddings in a datastore.
